(19) United States
(12) Patent Application Publication
(10) Pub. No.: US 2025/0175904 A1
(43) Pub. Date: May 29, 2025

(54) TRANSMITTER, POWER CONTROL CIRCUITRY, AND POWER CONTROL METHOD

(71) Applicant: REALTEK SEMICONDUCTOR CORPORATION, Hsinchu (TW)

(72) Inventors: Kai-Cheng HSU, Hsinchu (TW); Ting-An CHEN, Hsinchu (TW)

(21) Appl. No.: 18/818,666

(22) Filed: Aug. 29, 2024

(30) Foreign Application Priority Data
Nov. 24, 2023 (TW) 112145585

(51) Int. Cl. H04W 52/08; H04W 52/52

(52) U.S. Cl. CPC H04W 52/08; H04W 52/52

(57) ABSTRACT

A transmitter includes a power control circuitry and a front-end circuitry. The power control circuitry is configured to generate a first signal and perform a closed-loop power control according to the first signal to adjust a power of the first signal. The front-end circuitry is configured to amplify the first signal to generate a second signal and output the second signal via an antenna.

### BACKGROUND OF THE INVENTION

### 1. Field of the Invention

The present disclosure relates to a transmitter, especially to a transmitter, a power control circuitry, and a power control method that are able to perform an independent closed-loop power control.

### 2. Description of Related Art

In some communication applications, signal(s) generated by the transmitter are required to have higher power to support long-distance transmission. In these applications, the transmitter usually has an additional front-end circuit module to amplify the signal to be transmitted, thereby increasing the output power of the transmitter. However, this front-end circuit module usually has only a single gain, and the circuit specification thereof (e.g., input signal range) may not match other circuits in the transmitter, which reduces the actual usable range of the transmitter.

### SUMMARY OF THE INVENTION

In some aspects, an object of the present disclosure is to, but not limited to, provide a transmitter, a power control circuitry, and a power control method that are able to perform an independent closed-loop power control, so as to make an improvement to the prior art.

In some aspects, a transmitter includes a power control circuitry and a front-end circuitry. The power control circuitry is configured to generate a first signal and perform a closed-loop power control according to the first signal to adjust a power of the first signal. The front-end circuitry is configured to amplify the first signal to generate a second signal and output the second signal via an antenna.

In some aspects, a power control circuitry includes a transmitter circuit and a closed-loop power control circuit. The transmitter circuit is configured to output a first signal, in which the first signal is further amplified by a front-end circuitry to generate a second signal. The closed-loop power control circuit is configured to detect a power of the first signal and perform a closed-loop power control according to the power of the first signal to adjust the power of the first signal, in which the closed-loop power control is independent of the front-end circuitry.

In some aspects, a power control method includes the following operations: amplifying, by a front-end circuitry, a first signal to generate a second signal, and outputting the second signal via an antenna; and generating, by a power control circuitry, the first signal and performing a closed-loop power control according to the first signal to adjust a power of the first signal.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1A illustrates a schematic diagram of a transmitter according to some embodiments of the present disclosure.

FIG. 1B illustrates a schematic diagram showing the relationship between the actual power and the target power of the signal outputted by the transmitter in FIG. 1A under different bandwidth settings according to some embodiments of the present disclosure.

FIG. 2 illustrates a schematic diagram of a transmitter according to some embodiments of the present disclosure.

FIG. 3 illustrates a schematic diagram of the power control circuitry in FIG. 2 according to some embodiments of the present disclosure.

FIG. 4 illustrates a flowchart of a power control method according to some embodiments of the present disclosure

### DETAILED DESCRIPTION OF THE PREFERRED EMBODIMENTS

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

In this document, the term “coupled” may also be termed as “electrically coupled,” and the term “connected” may be termed as “electrically connected.” “Coupled” and “connected” may mean “directly coupled” and “directly connected” respectively, or “indirectly coupled” and “indirectly connected” respectively. “Coupled” and “connected” may also be used to indicate that two or more elements cooperate or interact with each other. In this document, the term “circuitry” may indicate a system implemented with at least one circuit, and the term “circuit” may indicate an object, which is formed with one or more transistors and/or one or more active/passive elements according to a specific arrangement, for processing signals.

As used herein, the term “and/or” includes any and all combinations of one or more of the associated listed items. Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. For ease of understanding, similar/identical elements in various figures are designated with the same reference number.

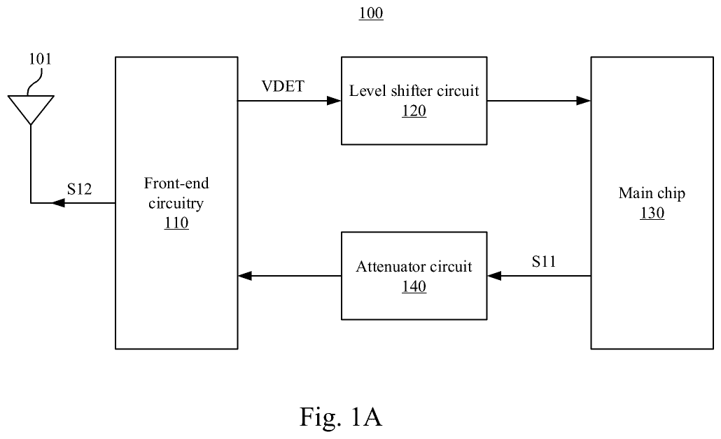

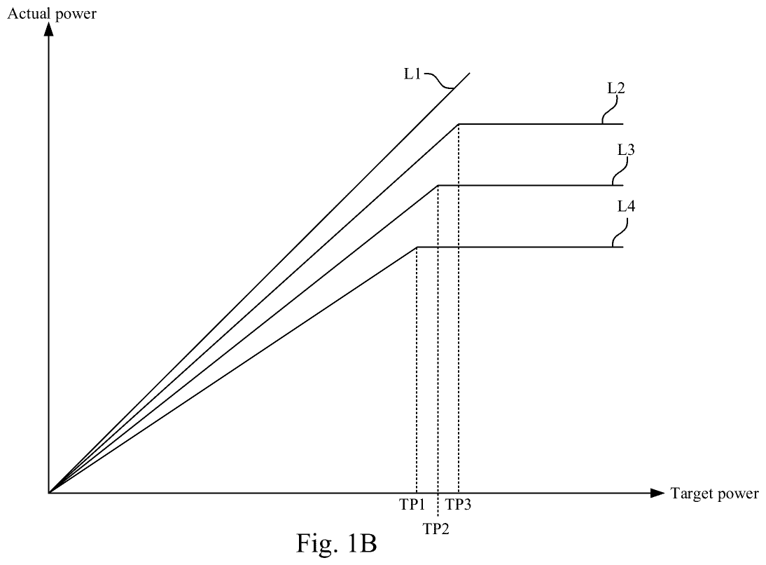

FIG. 1A illustrates a schematic diagram of a transmitter 100 according to some embodiments of the present disclosure. The transmitter 100 includes a front-end circuitry 110, a level shifter circuit 120, a main chip 130, and an attenuator circuit 140. The front-end circuitry 110 may be an additional transmitter module, which may be configured to amplify a signal S11 generated by the main chip 130 to generate a signal S12, and output the signal S12 via an antenna 101. In some applications, as the level range of the signal S11 may exceed an input signal range of the front-end circuitry 110, the attenuator circuit 140 may be employed to attenuate the signal S11 and provide the attenuated signal S11 to the front-end circuitry 110.

On the other hand, the front-end circuitry 110 may detect the power of the signal S12 to generate a detection signal VDET. The level shifter circuit 120 is coupled between the front-end circuitry 110 and the main chip 130 to convert the level of the detection signal VDET to a level suitable for the input range of the main chip 130. The main chip 130 may be an independent system-on-chip (SOC), which may be configured to generate the signal S11 to be transmitted. The main chip 130 may perform a power control according to the detection signal VDET to adjust the power of the signal S11 and/or the power of the signal S12. For example, the main chip 130 may adjust the amplification gain of the main chip 130 and/or the amplification gain of the front-end circuitry 110 according to the detection signal VDET, thereby adjusting the power of the signal S12. However, in practical applications, the front-end circuitry 110 and the main chip 130 may be products provided by different manufacturers. The front-end circuitry 110 may not have an adjustable gain mechanism, or the specifications of its detector circuit (which may be configured to detect the power of the signal S12 to generate the detection signal VDET) may not support the bandwidth range required for the current application, which limits the usable range of the transmitter 100.

For example, FIG. 1B illustrates a schematic diagram showing the relationship between the actual power and the target power of the signal S12 outputted by the transmitter 100 in FIG. 1A under different bandwidth settings according to some embodiments of the present disclosure. As shown in FIG. 1B, ideally, the target power and the actual power should be linearly proportional under different bandwidths (as shown by line segment L1). However, in practical applications, the front-end circuitry 110 may not be designed with sufficient consideration for peak-to-average power ratio (PAPR), which results in different signal saturation points for the front-end circuitry 110 under different bandwidth settings. As shown in FIG. 1B, when the bandwidth range is 20 MHz, the circuit saturation point of the front-end circuitry 110 corresponds to the target power TP3 (as shown by line segment L2). When the bandwidth range is 40 MHz, the circuit saturation point of the front-end circuitry 110 corresponds to the target power TP2 (as shown by line segment L3). When the bandwidth range is 80 MHz, the circuit saturation point of the front-end circuitry 110 corresponds to the target power TP1 (as shown by line segment L4). The target power TP1, target power TP2, and target power TP3 correspond to different values. Under this condition, if the signal range required by the current application is 20 MHz to 80 MHz, the target power that the transmitter 100 can provide is only the lower target power TP1. In other words, under this configuration, the usable range of the transmitter 100 will be limited by the actual circuit saturation.

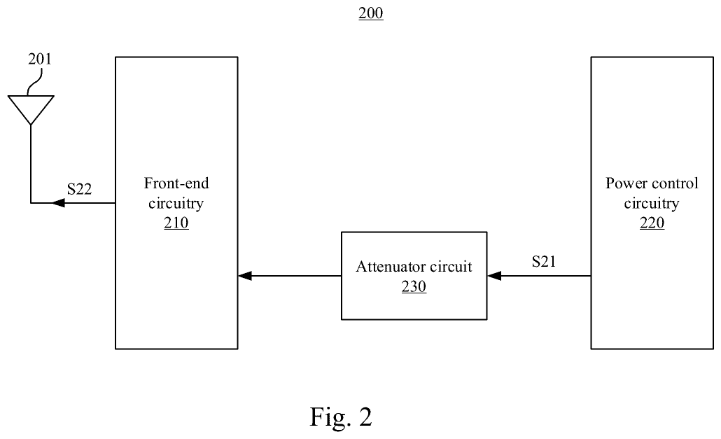

FIG. 2 illustrates a schematic diagram of a transmitter 200 according to some embodiments of the present disclosure. Different from FIG. 1A, the power adjustment mechanism in the transmitter 200 is a closed-loop control that is independent of the front-end circuitry. The transmitter 200 includes a front-end circuitry 210, a power control circuitry 220, and an attenuator circuit 230. Different from the transmitter 100, in this example, the power control circuitry 220 may independently perform a closed-loop power control, thereby adjusting the power of the signal S22 output by the transmitter 200 without receiving signals fed from the front-end circuitry 210.

The power control circuitry 220 may generate a signal S21. The front-end circuitry 210 may receive the signal S21 via the attenuator circuit 230 or directly receive the signal S21 from the power control circuitry 220 (if the input signal range of the front-end circuitry 210 is sufficient to directly receive the signal S21). The front-end circuitry 210 may amplify the signal S21 to generate a signal S22 and output the signal S22 via an antenna 201. In some embodiments, the additional amplification gain provided by the front-end circuitry 210 may increase the power of the signal S22 to meet high power requirements (for example, but not limited to, greater than or equal to 25 dBm) for some applications (e.g., wireless access points, drones, etc.).

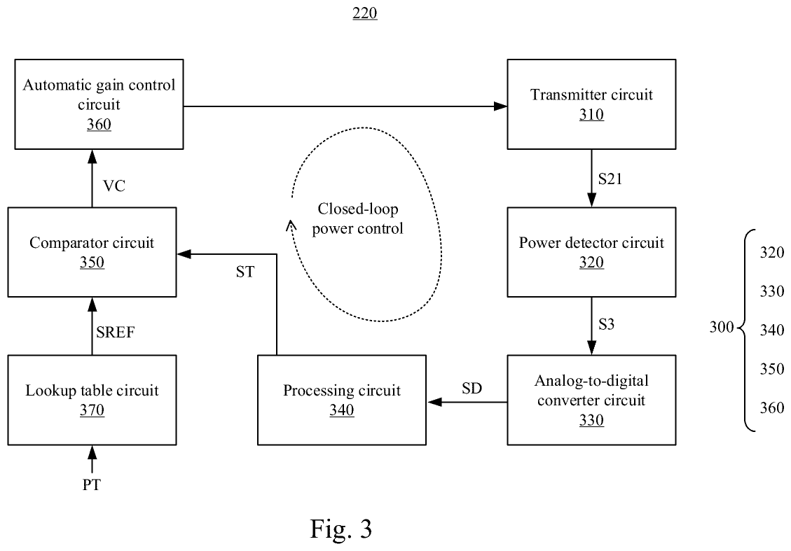

In this example, the power control circuitry 220 is further configured to detect the power of the signal S21 and generate a digital code (e.g., a digital code SD of FIG. 3) according to the power of the signal S21, thereby performing the closed-loop power control according to this digital code. In the example of FIG. 1A, the power control is implemented with a closed loop formed with all the circuits in FIG. 1A. Different from FIG. 1A, in the example of FIG. 2, the closed-loop power control is independently performed by the power control circuitry 220 in FIG. 2. In other words, the closed-loop power control performed by the power control circuitry 220 is independent of the front-end circuitry 210. That is, the power control circuitry 220 may perform the closed-loop power control without receiving signals from the front-end circuitry 210 (e.g., the detection signal VDET in FIG. 1A) to adjust the power of the signal S21, thereby adjusting the power of the final output signal S22. In some embodiments, when the power control circuitry 220 performs the closed-loop power control, the power control circuitry 220 does not adjust the amplification gain of the front-end circuitry 210 but only adjusts the amplification gain of the power control circuitry 220. In other embodiments, when the power control circuitry 220 performs closed-loop power control, the power control circuitry 220 may simultaneously adjust the amplification gain of both the front-end circuitry 210 and the power control circuitry 220. A configuration of the power control circuitry 220 will be described later with reference to FIG. 3.

With the above configuration, the usable range of the transmitter 200 is less limited by the circuit specifications of the front-end circuitry 210. In some applications, when the transmitter 200 does not need to use the additional gain provided by the front-end circuitry 210 (i.e., when the front-end circuitry is not used), the power control circuitry 220 may still perform the closed-loop power control through internal circuit(s) thereof to adjust the power of the signal S22. In other words, the transmitter 200 may be applied to various different applications, and may reduce the complexity of the overall power control. Furthermore, in the transmitter 200, as the power control circuitry 220 may not receive signals from the front-end circuitry 210, the transmitter 200 does not need to be equipped with a level shifter circuit, thereby saving circuit area and cost.

FIG. 3 illustrates a schematic diagram of the power control circuitry 220 in FIG. 2 according to some embodiments of the present disclosure. In some embodiments, the power control circuitry 220 includes a transmitter circuit 310, a power detector circuit 320, an analog-to-digital converter circuit 330, a processing circuit 340, a comparator circuit 350, an automatic gain control circuit 360, and a lookup table circuit 370, in which the power detector circuit 320, the analog-to-digital converter circuit 330, the processing circuit 340, the comparator circuit 350, and the automatic gain control circuit 360 are configured to operate as a closed-loop power control circuit 300. The transmitter circuit 310 may output the signal S21. For example, the transmitter circuit 310 may include an adjustable gain amplifier (not shown), which may set its amplification gain according to the control signal VC and amplify a data signal to be transmitted by the system, thereby outputting the amplified data signal as the signal S21. In some embodiments, the aforementioned adjustable gain amplifier may be implemented with a multi-stage amplifier circuit to increase the adjustable gain range.

The power detector circuit 320 may detect the power of the signal S21 to generate a signal S3. In some embodiments, the power detector circuit 320 may convert the signal S21 into a direct-current (DC) voltage, in which the level of this DC voltage is proportional to the power of the signal S3. For example, the power detector circuit 320 may filter and rectify the signal S21 to obtain the average DC level corresponding to the signal S21 and output this average DC level as the signal S3. In some embodiments, the power detector circuit 320 may be a root-mean-square (RMS) detector circuit. The configuration of the power detector circuit 320 described above is given for illustrative purposes only, and the present disclosure is not limited thereto.

The analog-to-digital converter circuit 330 generates the digital code SD according to the signal S3. In different embodiments, the analog-to-digital converter circuit 330 may be different types of analog-to-digital converter circuits, which may be, for example but not limited to, a pipeline analog-to-digital converter circuit, a flash analog-to-digital converter circuit, a successive approximation register analog-to-digital converter circuit, and so on. The processing circuit 340 executes a predetermined algorithm according to the digital code SD to generate a transmitter signal strength indicator (TSSI) signal ST. In some embodiments, the processing circuit 340 may correct the digital code SD according to an offset value (not shown) to generate the transmitter signal strength indicator signal ST. For example, the processing circuit 340 may include a sensing circuit (not shown) and an adder circuit (not shown). The sensing circuit may sense the current operating temperature, voltage variations, and other environmental parameters to generate the aforementioned offset value. The adder circuit may sum the offset value and the digital code SD to generate the transmitter signal strength indicator signal ST. The comparator circuit 350 generates the control signal VC according to the transmitter signal strength indicator signal ST and a reference indicator signal SREF. For example, the comparator circuit 350 may determine whether the transmitter signal strength indicator signal ST is the same as the reference indicator signal SREF. If the transmitter signal strength indicator signal ST is different from the reference indicator signal SREF, the comparator circuit 350 may determine the difference between the transmitter signal strength indicator signal ST and the reference indicator signal SREF and output this difference as the control signal VC.

The automatic gain control circuit 360 may adjust the amplification gain of the transmitter circuit 310 according to the control signal VC, thereby adjusting the power of the signal S21. For example, the automatic gain control circuit 360 may adjust the adjustable gain amplifier in the transmitter circuit 310 according to the difference indicated by the control signal VC to adjust the amplification gain of the transmitter circuit 310. The lookup table circuit 370 outputs the reference indicator signal SREF according to the target power signal PT. In some embodiments, the lookup table circuit 370 may be implemented with a memory circuit, thereby storing the corresponding relationship between different values of the target power signal PT and different values of the reference indicator signal SREF.

An example of the closed-loop power adjustment of the power control circuitry 220 is given as follows. In a first step, the target power is set. For example, the target power of the signal S21 is set to 16 dBm, and the target power signal PT is also set to a value corresponding to 16 dBm. In a second step, the amplification gain of the transmitter circuit 310 is set to the gain corresponding to the target power. In some embodiments, the first step and the second step may be performed by the digital circuit or a controller circuit in the system. In a third step, the power detector circuit 320 detects the power of the signal S21 to generate the signal S3, and the analog-to-digital converter circuit 330 generates the digital code SD according to the signal S3. For example, the value of the digital code SD may be 531. In a fourth step, the processing circuit 340 generates the transmitter signal strength indicator signal ST according to the digital code SD. For example, the processing circuit 340 may generate the transmitter signal strength indicator signal ST with a value of 292 according to the digital code SD with a value of 531. In a fifth step, the lookup table circuit 370 outputs the reference indicator signal SREF with a value of 300 (corresponding to the target power, i.e., the aforementioned 16 dBm) according to the target power signal PT. In a sixth step, the comparator circuit 350 compares the transmitter signal strength indicator signal ST with the reference indicator signal SREF to generate the control signal VC. For example, the comparator circuit 350 may determine that the transmitter signal strength indicator signal ST (with the value of 292) is different from the reference indicator signal SREF (with the value of 300), and thus the comparator circuit 350 outputs the difference (which is a value of 8) between the transmitter signal strength indicator signal ST and the reference indicator signal SREF as the control signal VC. In a seventh step, the automatic gain control circuit 360 adjusts the amplifier gain of the transmitter circuit 310 according to the control signal VC. By repeatedly performing the above steps, the power of the signal S21 may be gradually adjusted to be close to or equal to the target power.

From the above operations, it may be understood that the closed-loop power control circuit 300 may perform the closed-loop power control without receiving signals from the front-end circuitry 210. Equivalently, the closed-loop power control is independent of the front-end circuitry 210, such that the usable range (or adjustable voltage range) of the transmitter 200 will not be limited by the circuit specifications of the front-end circuitry 210. The various values mentioned in the above example are given for illustrative purposes, and the present disclosure is not limited thereto. Various arrangements of the power control circuitry 220 that are able to independently perform the closed-loop power control are within the contemplated scope of the present disclosure.

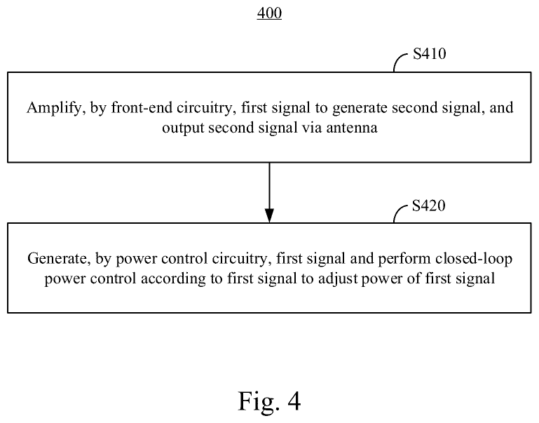

FIG. 4 illustrates a flowchart of a power control method 400 according to some embodiments of the present disclosure. The power control method 400 includes operation S410 and operation S420. In operation S410, a first signal is amplified by a front-end circuitry to generate a second signal, and the second signal is outputted via an antenna. In operation S420, the first signal is generated by a power control circuitry, and a closed-loop power control is performed according to the first signal to adjust the power of the first signal.

The above operations can be understood with reference to above embodiments, and thus the repetitious descriptions are not further given. The above description of the power control method 400 includes exemplary operations, but the operations of the power control method 400 are not necessarily performed in the order described above. Operations of the power control method 400 may be added, replaced, changed order, and/or eliminated, or the operations of the power control method 400 may be executed simultaneously or partially simultaneously as appropriate, in accordance with the spirit and scope of various embodiments of the present disclosure.

As described above, the transmitter, the power control circuitry, and the power control method provided in some embodiments of the present disclosure may perform a closed-loop power control that is independent of the front-end circuitry. As a result, it is able to avoid signal range mismatches between the front-end circuitry and the power control circuitry, thereby increasing the adjustable gain range of the transmitter. On the other hand, as the front-end circuitry is independent of the closed-loop power control, the power control circuitry may not receive signals from the front-end circuitry, thereby saving some circuit components (e.g., level shifter circuit) and reducing circuit area.

Various functional components or blocks have been described herein. As will be appreciated by persons skilled in the art, in some embodiments, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The aforementioned descriptions represent merely some embodiments of the present disclosure, without any intention to limit the scope of the present disclosure thereto. Various equivalent changes, alterations, or modifications according to the claims of present disclosure are all consequently viewed as being embraced by the scope of the present disclosure.

What is claimed is:

1. A transmitter, comprising:
a power control circuitry configured to generate a first signal and perform a closed-loop power control according to the first signal to adjust a power of the first signal; and
a front-end circuitry configured to amplify the first signal to generate a second signal and output the second signal via an antenna.

2. The transmitter of claim 1, wherein when the power control circuitry performs the closed-loop power control, the power control circuitry does not adjust an amplification gain of the front-end circuitry.

3. The transmitter of claim 1, wherein the power control circuitry is configured to detect the power of the first signal, generate a digital code according to the power of the first signal, and perform the closed-loop power control according to the digital code.

4. The transmitter of claim 1, wherein the power control circuitry comprises:
a transmitter circuit configured to output the first signal;
a power detector circuit configured to detect the power of the first signal to generate a third signal;
an analog-to-digital converter circuit configured to generate a digital code according to the third signal;
a processing circuit configured to generate a transmitter signal strength indicator signal according to the digital code;
a comparator circuit, configured to generate a control signal according to the transmitter signal strength indicator signal and a reference indicator signal; and
an automatic gain control circuit configured to adjust an amplification gain of the transmitter circuit according to the control signal to adjust the power of the first signal.

5. The transmitter of claim 4, wherein the power control circuitry further comprises:
a lookup table circuit configured to output the reference indicator signal according to a target power signal.

6. The transmitter of claim 1, wherein the closed-loop power control is independent of the front-end circuitry.

7. A power control circuitry, comprising:
a transmitter circuit configured to output a first signal, wherein the first signal is further amplified by a front-end circuitry to generate a second signal; and
a closed-loop power control circuit configured to detect a power of the first signal and perform a closed-loop power control according to the power of the first signal to adjust the power of the first signal,
wherein the closed-loop power control is independent of the front-end circuitry.

8. The power control circuitry of claim 7, wherein the closed-loop power control circuit does not receive a signal from the front-end circuitry.

9. The power control circuitry of claim 7, wherein the closed-loop power control circuit comprises:
a power detector circuit configured to detect the power of the first signal to generate a third signal;
an analog-to-digital converter circuit configured to generate a digital code according to the third signal;
a processing circuit configured to generate a transmitter signal strength indicator signal according to the digital code;
a comparator circuit configured to generate a control signal according to the transmitter signal strength indicator signal and a reference indicator signal; and
an automatic gain control circuit configured to adjust an amplification gain of the transmitter circuit according to the control signal to adjust the power of the first signal.

10. The power control circuitry of claim 9, further comprising:
a lookup table circuit configured to output the reference indicator signal according to a target power signal.

11. A power control method, comprising:
amplifying, by a front-end circuitry, a first signal to generate a second signal, and outputting the second signal via an antenna; and
generating, by a power control circuitry, the first signal and performing a closed-loop power control according to the first signal to adjust a power of the first signal.

12. The power control method of claim 11, wherein generating, by the power control circuitry, the first signal and performing the closed-loop power control according to the first signal to adjust the power of the first signal comprises:
not adjusting an amplification gain of the front-end circuitry when the power control circuitry performs the closed-loop power control.

13. The power control method of claim 11, wherein generating, by the power control circuitry, the first signal and performing the closed-loop power control according to the first signal to adjust the power of the first signal comprises:
detecting, by the power control circuitry, the power of the first signal;
generating, by the power control circuitry, a digital code according to the power of the first signal; and
performing, by the power control circuitry, the closed-loop power control according to the digital code.

14. The power control method of claim 11, wherein generating, by the power control circuitry, the first signal and performing the closed-loop power control according to the first signal to adjust the power of the first signal comprises:
outputting, by a transmitter circuit in the power control circuitry, the first signal;
detecting, by a power detector circuit in the power control circuitry, the power of the first signal to generate a third signal;
generating, by an analog-to-digital converter circuit in the power control circuitry, a digital code according to the third signal;
generating, by a processing circuit in the power control circuitry, a transmitter signal strength indicator signal according to the digital code;
generating, by a comparator circuit in the power control circuitry, a control signal according to the transmitter signal strength indicator signal and a reference indicator signal; and
adjusting, by an automatic gain control circuit in the power control circuitry, an amplification gain of the transmitter circuit according to the control signal to adjust the power of the first signal.

15. The power control method of claim 14, further comprising:
outputting, by a lookup table circuit in the power control circuitry, the reference indicator signal according to a target power signal.

16. The power control method of claim 11, wherein the closed-loop power control is independent of the front-end circuitry.
